(19) United States
(12) Patent Application Publication
(10) Pub. No.: US 2005/0056782 A1
(43) Pub. Date: Mar. 17, 2005

(54) Near field acoustic holography with scanning probe microscope (SPM)

(76) Inventors: Gajendra Shekhawat, Arlington Heights, IL (US); Vinayak P. Dravid, Glenview, IL (US)

Correspondence Address: MCANDREWS HELD & MALLOY, LTD, 500 WEST MADISON STREET, SUITE 3400, CHICAGO, IL, 60661, US

(21) Appl. No.: 10/913,086

(22) Filed: Aug. 6, 2004

Related U.S. Application Data
(60) Provisional application No. 60/494,532, filed on Aug. 12, 2003.

(51) Int. Cl. G01N 23/00

(52) U.S. Cl. 250/306

(57) ABSTRACT

A high spatial resolution phase-sensitive technique employs a near field ultrasonic holography methodology for imaging elastic as well as viscoelastic variations across a sample surface. Near field ultrasonic holography (NFUH) uses a near-field approach to measure time-resolved variations in ultrasonic oscillations at a sample surface. As such, it overcomes the spatial resolution limitations of conventional phase-resolved acoustic microscopy (i.e. holography) by eliminating the need for far-field acoustic lenses.

### CROSS-REFERENCE TO RELATED APPLICATIONS

This application claims the priority of provisional application Ser. No. 60/494,532 filed Aug. 12, 2003. That application is hereby incorporated herein by reference.

### STATEMENT REGARDING FEDERALLY SPONSORED RESEARCH OR DEVELOPMENT

N/A

### BACKGROUND OF THE INVENTION

Known acoustic microscopes are used for imaging structures such as integrated circuit (IC) structures. The spatial resolution, w, of an acoustic microscope is given by:

$$w = 0.51 \frac{ϑ}{f \cdot N A}$$

where θ is the speed of sound in the coupling medium, f is the frequency of the acoustic/ultrasonic wave, and N.A. is the numerical aperture of the lens. For a frequency of 1 GHz, the nominal spatial resolution attainable is approximately 1.5 μm. Further, the acoustic microscope has two other major roadblocks in getting high resolution: (1) impedance mismatches and coupling fluid attenuation that is proportional to f. Higher resolution alternatives for nondestructive mechanical imaging include the atomic force microscope (AFM) or scanning probe microscope (SPM) platforms. A few examples include: force modulation microscopy (FMM) as described by P. Maivald, H. J. Butt, S. A. C. Gould, C. B. Prater, B. Drake, J. A. Gurley, V. B. Elings, and P. K. Hansma in Nanotechnology 2, 103 (1991); ultrasonic-AFM as described by U. Rabe and W. Arnold in Appl. Phys. Lett. 64, 1423 (1994); and ultrasonic force microscopy (UFM) as described by O. V. Kolosov, K. Yamanaka in Jpn. J. Appl. Phys. 32, 1095 (1993); by G. S. Shekhawat, O. V. Kolosov, G. A. D. Briggs, E. O. Shaffer, S. Martin and R. Geer in Nanoscale Elastic Imaging of Aluminum/Low-k Dielectric Interconnect Structures, presented at the Material Research Society, Symposium D, April 2000 and published in Materials Research Society Symposium Proceedings, Vol. 612 (2001) pp. 1.; by G. S. Shekhawat, G. A. D. Briggs, O. V. Kolosov, and R. E. Geer in Nanoscale elastic imaging and mechanical modulus measurements of aluminum/low-k dielectric interconnect structures, Proceedings of the International Conference on Characterization and Metrology for ULSI Technolog, AIP Conference Proceedings. (2001) pp. 449; by G. S. Shekhawat, O. V. Kolosov, G. A. D. Briggs, E. O. Shaffer, S. J. Martin, R. E. Geer in Proceedings of the IEEE International Interconnect Technology Conference, 96-98, 2000; by K. Yamanaka and H. Ogiao in Applied Physics Letters 64 (2), 1994; by K. Yamanaka, Y. Maruyama, T. Tsuji in Applied Physics Letters 78 (13), 2001; and by K. B. Crozier, G. G. Yaralioglu, F. L. Degertekin, J. D. Adams, S. C. Minne, and C. F. Quate in Applied Physics Letters 76 (14), 2000. Each of these techniques is traditionally sensitive to the static elastic properties of the sample surface.

Recent developments in atomic force microscopes have involved the application of ultrasonic frequency (MHz) vibrations to the sample under study and non-linearly detecting of the deflection amplitude of the tip at the same high frequencies. With this arrangement, which is commonly identified as an ultrasonic force microscope, the ultrasonic frequencies employed are much higher than the resonant frequency of the microscope cantilever. The microscope exploits the strongly non-linear dependence of the atomic force on the distance between the tip and the sample surface. Due to this non-linearity, when the surface of the sample is excited by an ultrasonic wave, the contact between the tip and the surface rectifies the ultrasonic vibration, with the cantilever on which the tip is mounted being dynamically rigid to the ultrasonic vibration. The ultrasonic force microscope enables the imaging and mapping of the dynamic surface viscoelastic properties of a sample and hence elastic and adhesion phenomenon as well as local material composition which otherwise would not be visible using standard techniques at nanoscale resolution.

The drawback of ultrasonic microscopy is that it measures only the amplitude due to ultrasonically induced cantilever vibrations. Moreover, where the sample is particularly thick and has a very irregular surface or high ultrasonic attenuation, only low surface vibration amplitude may be generated. In such circumstances the amplitude of vibration may be below the sensitivity threshold of the microscope in which case measurement is impossible. Moreover, none of the above mentioned techniques measures with high resolution the acoustic phase, which is very sensitive to subsurface elastic imaging and deep defects identification which are lying underneath the surface, without doing any cross sectioning of the samples.

### BRIEF SUMMARY OF THE INVENTION

The present invention relates to a high spatial resolution phase-sensitive technique, which employs a near field ultrasonic holography methodology for imaging elastic as well as viscoelastic variations across a sample surface. Near field ultrasonic holography (NFUH) uses a near-field approach to measure time-resolved variations in ultrasonic oscillations at a sample surface. As such, it overcomes the spatial resolution limitations of conventional phase-resolved acoustic microscopy (i.e. holography) by eliminating the need for far-field acoustic lenses.

The fundamental static and dynamic nanomechanical imaging modes for the instrument of the present invention are based on nanoscale viscoelastic surface and subsurface imaging using two-frequency ultrasonic holography. The ‘near-field’ ultrasonic technique of the present invention vibrates both the cantilevered tip and the sample at ultrasonic frequencies. The nonlinear tip-sample interaction enables the extraction of the heterodyne interference signal between the two ultrasonic vibrations so that the spatial variation of the surface/subsurface viscoelastic phase (relative to the tip carrier wave) can be imaged. This defines a characteristic viscoelastic response time of the sample and enables the extraction of subsurface mechanical data including interfacial bonding. The present invention is capable of imaging deep inside the sample. Moreover, the invention exploits the amplitude of the acoustic interference as well as phase sensitivity.

These and other advantages and novel features of the present invention, as well as details of an illustrated embodiment thereof, will be more fully understood from the following description and drawings.

### BRIEF DESCRIPTION OF THE SEVERAL VIEWS OF THE DRAWING

FIG. 1 is a block diagram illustrating the scanning probe microscope with near field ultrasonic holography of the present invention;

FIG. 2 is an illustration of atomic force microscopy of the present invention with a vibrating cantilever tip and vibrating sample;

FIG. 3 is a perspective view of polymer-metal IC test structures;

FIG. 4 is an illustration of topography and viscoelastic NFUH phase response imaging of the polymer-metal IC test structure of FIG. 2;

FIG. 5 is an illustration of NFUH images on a chemical mechanically polished surface of metal polymer trenches;

FIG. 6 is an illustration of cross-sectional AFM topography imaging and NFUH nanoscale elastic imaging of test structures containing spin-on-glass materials; and

FIG. 7 is an illustration of topography and nanoscale elastic images of carbon nanofiber deposited via chemical vapor deposition.

### DETAILED DESCRIPTION OF THE INVENTION

The present invention is directed to a nondestructive, general-use nanomechanical imaging system. The system is capable of directly and quantitatively imaging the elastic (static) and viscoelastic (dynamic) response of a variety of nanoscale materials and device structures with spatial resolution of a few nanometers. Performance targets for the relative and absolute elastic modulus resolution of this instrument are 50 MPa and 0.5 GPa, respectively. For viscoelastic (dynamic) nanomechanical imaging the target maximum probe frequency is around 80 MHz. The maximum relative phase resolution at this frequency is estimated to be 1° leading to a viscoelastic time resolution of approximately 30 ps. The instrument of the present invention operates in a manner similar to commercially available scanning probe microscopes (SPMs) in that quantitative, digital, rastered, nanometer-scale images are obtained of the sample elastic modulus, and sample viscoelastic response frequency. The instrument also provides conventional SPM imaging modes including topography, frictional, and force modulation imaging.

The applications for the present invention are numerous and represent areas of critical need in Nanoelectronics, Microsystems (MEMS), and Nanotechnology, in general. By combining the nanometer-scale spatial resolution of conventional SPMs with the elastic imaging capabilities of acoustic or ultrasonic microscopes, the instrument fills a critical need in characterizing and investigating the static and dynamic mechanics of nanoscale systems. The static and dynamic nanomechanical imaging modes of the present invention are designed to be completely nondestructive and compatible with sample sizes up to and including 200 mm Si wafers. The static mode is applicable to virtually any ex-situ sample geometry compatible with conventional ‘top-down’ SPM operation. The dynamic mode is slightly more restrictive, typically requiring sample geometries of overall thickness less than 8 mm (but with lateral width up to 200 mm). However, these requirements are compatible with a wide majority of material and device geometries encountered in nanotechnology development. The Near Field Ultrasonic Holography (NFAH) microscope and method have been used for: (1) investigating mechanical uniformity and process-induced mechanical modification of materials in integrated circuit (IC) damascene processing and MEMS fabrication; (2) cross-sectional analysis for characterization of depth-dependent modulus variation in IC and MEMS structures and (3) nanomechanical Imaging of Nanocomposite Materials.

The fundamental static and dynamic nanomechanical imaging modes for the instrument of the present invention are based on Nanoscale viscoelastic surface and subsurface imaging using two-frequency ultrasonic holography. This is essentially a ‘near-field’ ultrasonic technique, where both the cantilevered tip 10 and the sample 12 are vibrated at ultrasonic frequencies. The nonlinear tip-sample interaction enables the extraction of the heterodyne interference signal between the two ultrasonic vibrations so that the spatial variation of the surface/subsurface viscoelastic phase (relative to the tip carrier wave) can be imaged. This defines a characteristic viscoelastic response time of the sample and enables the extraction of subsurface mechanical data including interfacial bonding. The term ‘near-field’ is used for this approach since the nanoprobe-scanning tip 10 replaces far-field ultrasonic lenses.

The present invention provides a system that measures subsurface defects, delaminations; cracks; stress migration and etc., while maintaining the high resolution of the atomic force microscope. It utilizes (1) an atomic force microscopy apparatus having a cantilever 14 with a tip 10 at a free end sitting on top of the vibrating device 16 for supplying vibrations to the cantilever at a frequency greater than cantilever resonance frequency, (2) a sample 12 having a vibration device 18 sitting under it for providing high frequency excitations and (3) an optical detector 20 for detecting movement of the tip in dependence on a atomic force between the tip and the surface of a sample characterized. It detects the beat frequencies when the vibrating tip interacts with the vibrating sample, which falls within its detection range. With this embodiment, it is possible to recover phase information of the tip-surface mechanical interaction, which allows measurement of viscoelastic properties and enables the application of acoustic holography algorithms for imaging nanoscale sized sub-surface defects.

The primary design concept for viscoelastic (dynamic) nanomechanical imaging uses two ultrasonic vibrations. One ultrasonic vibration is applied to the tip 10, while a second ultrasonic vibration is applied to the sample 12:
z_{S}=A_{S} cos(ω_{S}t+φ_{S})
zₜᵢₚ=Aₜᵢₚ cos(ωₜᵢₚt) (Eq. 1)

Here, the tip vibration waveform acts as a temporal reference. The temporal phase delay associated with the surface vibration waveform is designated by φ_{S}. A linear force-displacement relationship between the tip 10 and sample 12 would result in no average cantilever deflection. However, a nonlinear force-displacement curve yields a heterodyne coupling between the two oscillations. This is seen by expanding the tip-sample force in a Taylor's series to second order in the tip-sample separation and calculating the average force responsible for cantilever deflection:

$$\\ \begin{matrix}{k}_{c} 〈 {z}_{tip} ( {ω}_{TIP} , {ω}_{S} , {A}_{TIP} {A}_{S} ) 〉 = \frac{1}{τ} {\int }_{0}^{τ} F ( {z}_{TIP} - {z}_{S} ) ⅆ t \\ = \frac{1}{τ} {\int }_{0}^{τ} ( {χ}_{1} ( {z}_{TIP} - {z}_{S} ) + {{χ}_{2} ( {z}_{TIP} - {z}_{S} )}^{2} + … ) ⅆ t\end{matrix} \qquad ( Eq . 2 )$$

where χ1 and χ2 denote first and second order ‘spring constants’, respectively, associated with the force-displacement curve and k_{c} is cantilever spring constant To simulate the cantilever deflection resulting from both oscillations, the equations of Eq. 1 are substituted into the equation of Eq. 2 and time-averaged over the response time, τ, of the SPM photodiode detector (hundreds of kHz). Only the nonlinear term is non-vanishing. Here, t is a relaxation time or phase delay time associated with the surface vibration resulting from a time-dependent mechanical process within the material. An arbitrary constant phase φ_{TIP} is associated with the tip vibration. The heterodyne nature of this deflection is illustrated by assuming a weak nonlinearity represented by non-vanishing 2^{nd} order susceptibility, χ₂, above. Assuming that the high-frequency response of the cantilever vibrations is beyond the temporal resolution of the SPM photodiode, the average deflection is simply calculated to be:

$$〈 {z}_{tip} ( {ω}_{tip} , {ω}_{S} , {A}_{tipP} {A}_{S} ) 〉 = \frac{{χ}_{2}}{{k}_{c}} \{ \frac{{A}_{tip}^{2}}{2} - {A}_{tip} {A}_{S} cos [ ( {ω}_{tipP} - {ω}_{S} ) t - {ϕ}_{S} ] + \frac{{A}_{S}^{2}}{2} \} \qquad ( Eq . 3 )$$

The implications of this simple calculation are extremely significant. The deflection of the tip is now dynamically linked to the viscoelastic response of the sample to the ultrasonic vibration. The phase term, φ_{S}, represents the dissipative lag/lead in the surface response with respect to the tip reference frequency. In the vicinity of an interface this dissipation is directly linked to a local loss tangent, indicative of the adhesive or interfacial bonding strength. Extracting the spatial dependence of this phase term provides image contrast indicative of the dynamics of materials, material interfaces, and defect structures with the same nanometer spatial resolution as AFM.

The heterodyne amplitude and phase are experimentally extracted from the tip deflection signal via conventional lock-in detection. The phase sensitivity of this measurement is critical in extracting time-resolved mechanical properties of materials as well as potentially enabling subsurface imaging. It is noted that the oscillation amplitudes used for NFUH are sufficiently large such that more detailed modeling may be required to include more complex higher order couplings.

Because the present invention utilizes acoustic wave phase detection via a scanning probe heterodyne detector, the system does not need far-field acoustic lenses and couplers. The present invention detects the phase of transmitted acoustic wave directly at wafer/deice surface. Further, the present invention detects the phase of transmitted acoustic wave directly at wafer/deice surface. Further, the present invention utilizes scanning nanoprobe phase detection so as to eliminate the need for acoustic lenses. The Nanoprobe Acoustic Antenna (AFM Tip) of the present invention is advantageous because it provides induction of MHz-GHz nanoprobe mechanical oscillations via high frequency flexural mode excitation, i.e. the mechanical wave guide and the heterodyne detection mode monitors the phase shifts between tip 10 and sample 12 acoustic/ultrasonic vibrations.

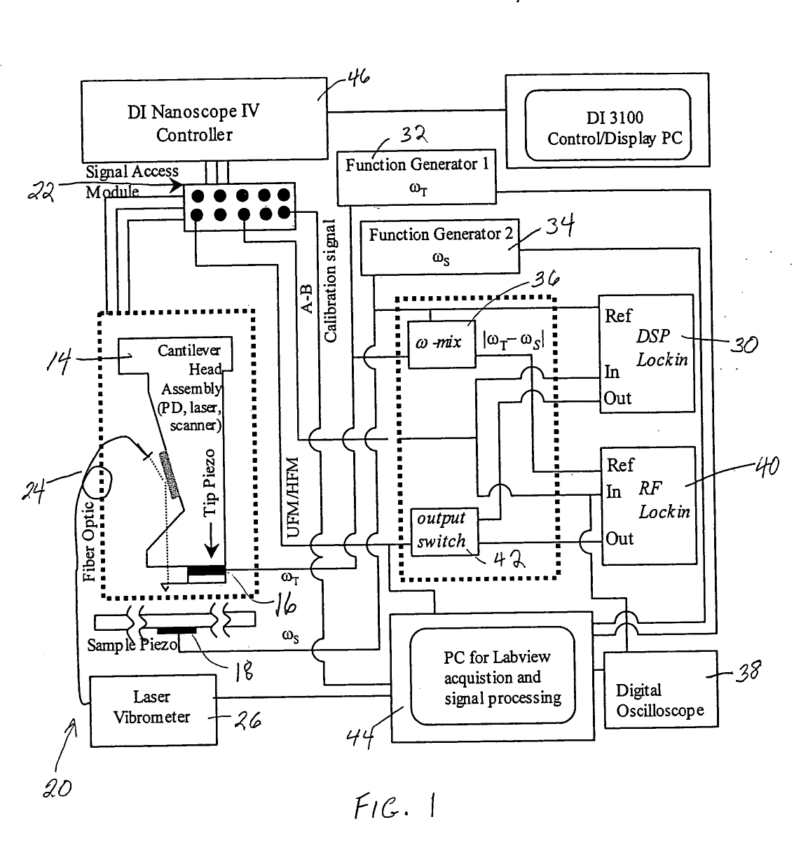

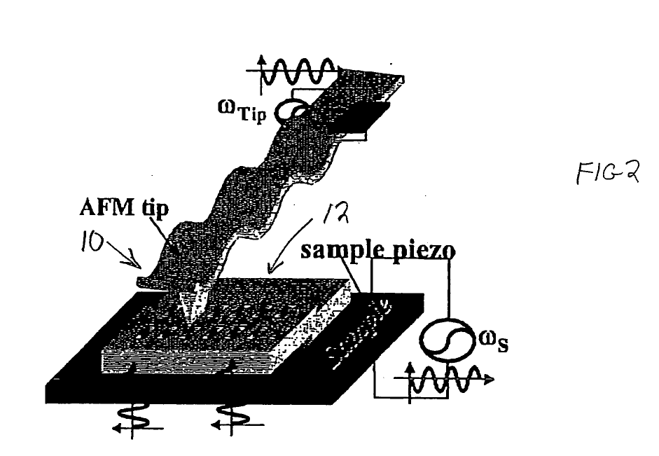

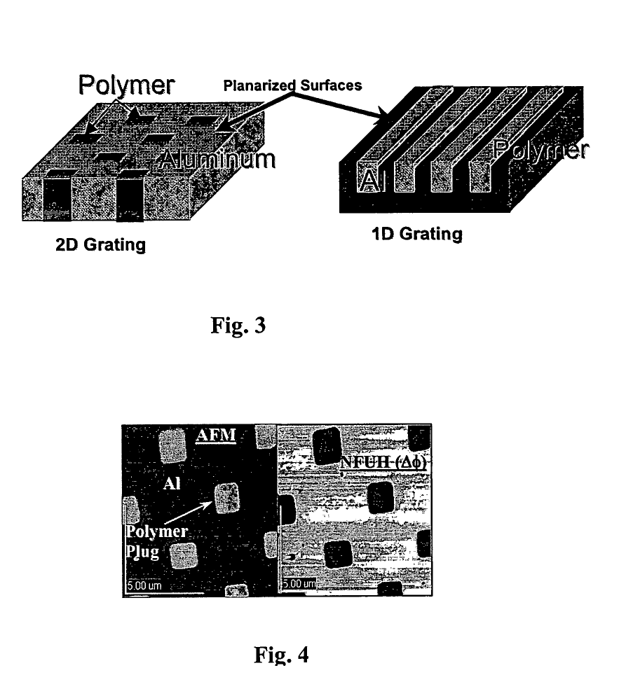

As shown in FIGS. 1 and 2, the two oscillations are applied to the tip 10 and sample 12 by two matched piezo crystals 16 and 18 attached to the Si substrate of the tip and the base of the sample, respectively. Each piezo 16, 18 is driven by a separate waveform with a simple mixer/filter circuit 36 providing the heterodyne frequency to an RF lockin amplifier 40 for amplitude (χ₂) and phase (φ_{S}) extraction.

Any Scanning Probe Microscopy (SPM) may serve as the base platform. A signal access module (SAM) 22 is used as the input site for NFUH, and modulus-calibration signals. Two mechanical modifications to the SPM cantilever head assembly are made: (1) an electrical contact assembly with spring-pin contacts is attached for insertion of piezo-integrated cantilevers on the underside of the head assembly 14; and (2) a fiber-optic and mirror mount 24 is attached to enable access of a laser beam vibrometer 26 to the backside of the cantilever 14 for direct measurement of the oscillation amplitude.

The integrated piezo (for high frequency excitation) will enable ultrasonic excitation of higher-order flexural resonances of the cantilever tip 10 to provide the OT ultrasonic vibration. An Agilent E5100A network analyzer is used to characterize the various higher-order flexural mode resonant frequencies to confirm cantilever-design specifications (Q, fₒ). In the case of NFUH acquisition, the latter is designed to match the resonance of the sample piezo within 0.8 MHz (detection limit of optical detector).

The sample ultrasonic vibration is driven by an Agilent 33250A function generator 32. The resulting A-B signal is accessed with the signal access module (SAM) 22 and acts as the input to a digital oscilloscope 38 and an SR830 DSP lockin amplifier 30 for extraction of the nonlinear UFM (Ultrasonic Force Microscopy) tip response at the modulation frequency. The lockin response signal will constitute a 2^{nd} channel input into the signal acquisition electronics 46, via the SAM 22, for image display and analysis. SPM controller acquisition of the UFM signal is simultaneous with AFM feedback and topography signals. For NFUH operation, a second function generator 34 (Agilent 3320A) applies the sample ultrasonic vibration. A standard mixer/filter circuit 36 is used to extract the heterodyne frequency |ω_{T}−ω_{S}| to serve as reference for a SR844 RF lockin amplifier 40. The A-B signal is input, via the SAM 22, into the RF lockin. The resulting output constitutes the NFUH image signal. A simple switch circuit 42 selects either the NFUH or UFM signal for acquisition. The NFUH signal is input into the SAM 22 for display and analysis. A maximum NFUH carrier frequency of 80 MHz is targeted implying a minimum measurable φ_{S} of 1° (30 ps viscoelastic relaxation at 80 MHz). A PC 44 running Lab View data acquisition/analysis software acquires both the A-B signal from the digital scope and the lockin.

The sample piezo consists of an insulator/electrode/piezo/electrode/insulator blanket multilayer (1 cm×1 cm) stack. The insulators consist of epoxied machinable ceramics or thin, spin-cast polymer coatings, dependent upon ultrasonic coupling efficiency. The Cr/Au electrodes provide electrical contact between the piezo and the second function generator 34. The assembly is counter-sunk into a modified SPM sample mount. For NFUH operation the sample may either utilize a vacuum mount to enable ultrasonic contact with the sample piezo or a commercial heat sheet will be incorporated to provide the minor heating (about 60° C.) necessary to melt the phenyl salicilate currently used to provide the mechanical link between the sample and the sample piezo.

Viscoelastic nanomechanical imaging as shown in FIG. 4 has been obtained on polymer-metal IC test structures illustrated in FIG. 2. The viscoelastic contrast between Al (metal) and Benzocyclobutene (BCB) regions is readily apparent. It is estimated that the Al/BCB image contrast corresponds to a viscoelastic temporal response differential of 5 ns. The images of FIG. 4 were taken at ultrasonic frequencies of 2 MHz. The right image denotes a relative elastic image map with the bright areas (Al) differentiated from the dark areas (BCB) on the basis of elastic modulus. The addition of high-frequency capability (up to 80 MHz) may be implemented for high phase resolution.

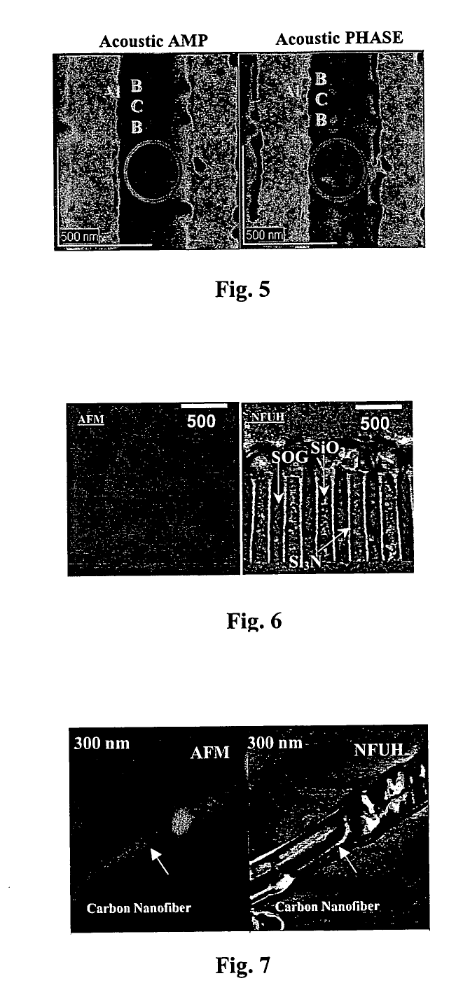

Similarly, FIG. 5 shows NFUH images on chemical mechanically polished (CMP) surface of metal polymer trenches. These are patterned via photolithography and etched by reactive ions (RIE) into a low-k dielectric blanket film. The resulting patterned is completely filled (metallized). Excess metal is removed CMP resulting in a globally flat inlaid metal wiring pattern in a low-k film. It has been shown that the RIE process alters the composition and mechanical response of low-k polymer dielectrics. Likewise, the CMP process, which induces significant shear stresses, can result in cohesive failure within the low-k dielectric or adhesive failure (delamination) at the metal/low-k interface. An objective of using NFUH is to carry out: (1) quantitative nanomechanical elastic (static) mapping of these structures to identify process-induced mechanical variations and/or nanoscale cohesive defects; and (2) nanomechanical viscoelastic (dynamic) imaging to specifically investigate surface and subsurface interfacial adhesive (bonding) response. The finest variation in phase signal obtained at 2 MHz corresponds to phase delay of 500 ps. NFUH amplitude depends only on surface modulus and subsurface mechanical defects.

NFUH acoustic phase corresponds to surface and subsurface variations in addition to time-of-flight delay of acoustic or ultrasonic waves. NFUH has also been implemented to investigate cross-sectional elastic characterization of IC/MEMS structures and multilayer stacks to provide direct z-axis imaging of variations in elastic modulus and viscoelastic response. Such capabilities complement current cross-sectional imaging techniques such as SEM-EDS, TEM-EDS, TEM-EELS, and ex situ STM to investigate the nanomechanics of material interfaces, the uniformity of conformally deposited coatings, and mechanical defects in multilayer structures. Cross-sectional nanomechanical (NFUH) analyses have been carried out on IC test structures containing spin-on-glass (SOG) materials. The data are shown in FIG. 6. The cross-sectional sample was prepared following spin coating of a silicate SOG onto SiO₂ trenches coated with a thin layer of Si₃N₄. The AFM topography (left image) of the cross-section is essentially featureless as expected. The NFUH image, in contrast, displays the relative elastic modulus variation between the SiO₂ trench walls, the SOG gap-fill materials and the Si₃N₄ trench-wall coating. More importantly, variations within the SOG and SiO₂ components are evident and raise the possibility of using such an instrument for quantitative deposition process control.

The application of nondestructive ultrasonics to composite materials (such as carbon nanotubes) is the subject of a substantial literature. The NFUH approach of the present invention has been applied to these materials and has significant advantages over currently available techniques such as AFM. NFUH of nanomechanical uniformity along a carbon nanofiber (100 nm nominal diameter) deposited via chemical vapor deposition (CVD) is demonstrated in FIG. 7. Mechanical non-uniformities along the fiber axis are clearly evident and reflect the fiber domain growth modes during CVD.

Other applications for the system and method of the present invention include: (1) non-destructive imaging of subsurface defects in 3D interconnects and stress migration along the devices due to electrical biasing; (2) non-destructive inspection for interconnect nanotechnology for nanometer-scale resolution, to enable imaging of electromechanical defects (e.g. nanotube contacts) and to enable imaging of nanoscale integrity in molecular interconnect assemblies; (3) subsurface nano-cracks, stress, delamination identification in ferroelectrics, ceramics and micromechanical structures and devices; (4) non-destructive defect review and process control in integrated IC materials and devices to provide modulus measurement for soft materials (i.e. porous dielectrics) and to provide void and delamination defect detection to avoid off-line, cross-sectional failure analysis; (5) self assembled monolayers and subsurface defects in biological cells and materials; and (6) quantitative extraction of Young's modulus with high accuracy.

Many other applications of the present invention as well as modifications and variations are possible in light of the above teachings.

1. A near field holography method for surface and subsurface imaging comprising:
vibrating a cantilevered tip at a first ultrasonic frequency;
vibrating a sample at a second ultrasonic frequency;
detecting movement of the cantilevered tip interacting with the vibrating sample to provide a tip deflection signal; and
extracting amplitude and phase information associated with the surface and subsurface of the sample from the tip deflection signal using lock in detection.
